(19) United States
(12) Patent Application Publication
(10) Pub. No.: US 2006/0278260 A1
(43) Pub. Date: Dec. 14, 2006

(54) Locking mechanism for foldable walker

(75) Inventor: Shih-Peng Su, Yunlin County (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 11/431,079

(22) Filed: May 10, 2006

(30) Foreign Application Priority Data
Jun. 9, 2005 (TW) 094209602

(51) Int. Cl. A61H 3/00

(52) U.S. Cl. 135/67

(57) ABSTRACT

A locking mechanism for use with a walker having a frame including a pair of fixed tubes, each lower end of the fixed tube being connected to a securer. A securing piece extends from the securer and is embraced by a rotating ring which can be rotated along with a handle bar. Upon rotating the handle bar for operation, the securing piece is compressed by the rotating ring and further secures a supporting leg with its resilience so as to reduce shaking of the supporting leg. Therefore, better stability of the walker is achieved.

### FIELD OF THE INVENTION

The present invention relates to a mechanism for a walker and more particularly, to a locking mechanism which can be connected to a foldable walker to stabilize and reduce shaking of the walker legs.

### DESCRIPTION OF THE RELATED ART

There is an increased demand for products to aid invalid people, such as walker products. Such walkers can support and assist the invalid people while walking.

A conventional walker is commonly provided for a user to move and be supported by both hands, similarly to using a cane. Therefore, the structure of the walker tends to be designed as simple and portable as possible. A frame structure of a conventional walker is applicable for the user with different figures and is provided with a height adjustment assembly, such as a telescopic device comprising telescoped inner and outer tubes. A button is usually provided to adjust the height or length of the legs.

Nevertheless, in order to adjust the frame smoothly, the internal diameter of the outer tube is a little bit bigger than the external diameter of the inner tube upon assembling, It easier for the user to adjust the height of the telescopic device if the common difference is bigger between the tubes. But the bigger difference between the tubes causes shaking in operation. Such shaking can become worse especially when the telescopic device is over extended and less length of the inner tube is inside the outer tube. This can become dangerous to the user while operating the walker.

### SUMMARY OF THE INVENTION

In order to overcome the drawbacks of the telescopic device of the prior art which can make the user feel insecure, the present invention provides a solution for a walker frame. A pair of fixed tubes of the frame each have a securer fixed to their lower ends. A securing piece extends from the securer and is covered by a rotating ring wherein the rotating ring compresses the securing piece in operation, with the securing piece securing a supporting leg. Therefore, shaking of the supporting leg is reduced and better stabilization of the walker is achieved.

Additional objects and advantages of the invention will be set forth in the following description and it is easy for a person having ordinary skill in this art to infer other variations from above illustrations and embodiments. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1 is a perspective view of the present invention.

FIG. 2 is an exploded perspective view of the present invention.

FIG. 3 is a cross sectional view of the foldable device of the present invention.

FIG. 4 is a perspective view of the frame of the present invention in the folded state.

FIG. 5 is a schematic view of the securing device of the present invention in the state of not being secured.

FIG. 6 is a schematic view of the securing device of the present invention in the state of being secured.

### DETAILED DESCRIPTION OF THE PREFERRED EMBODIMENTS

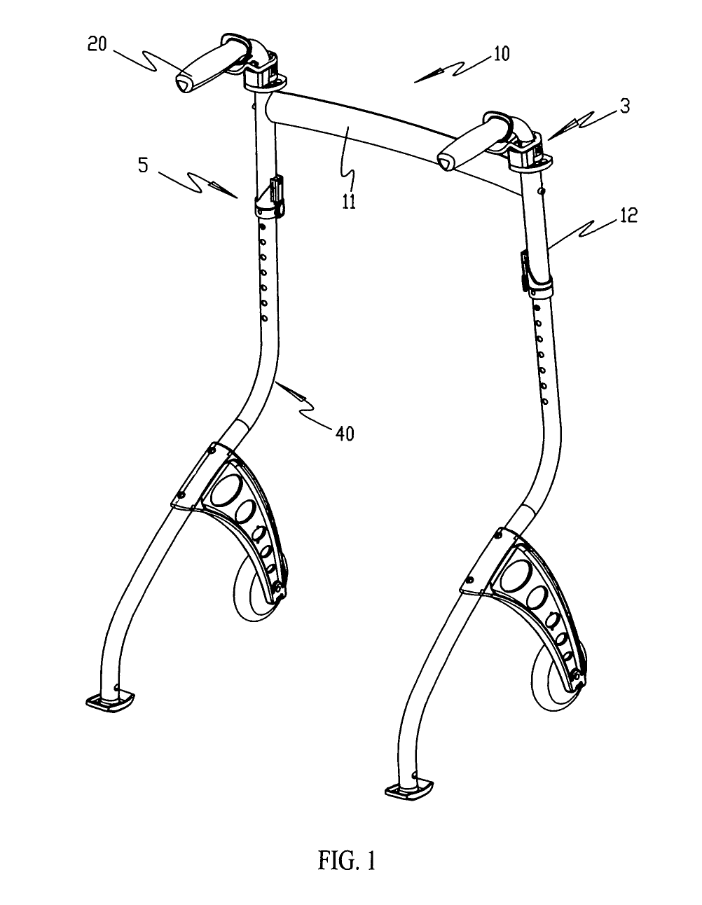

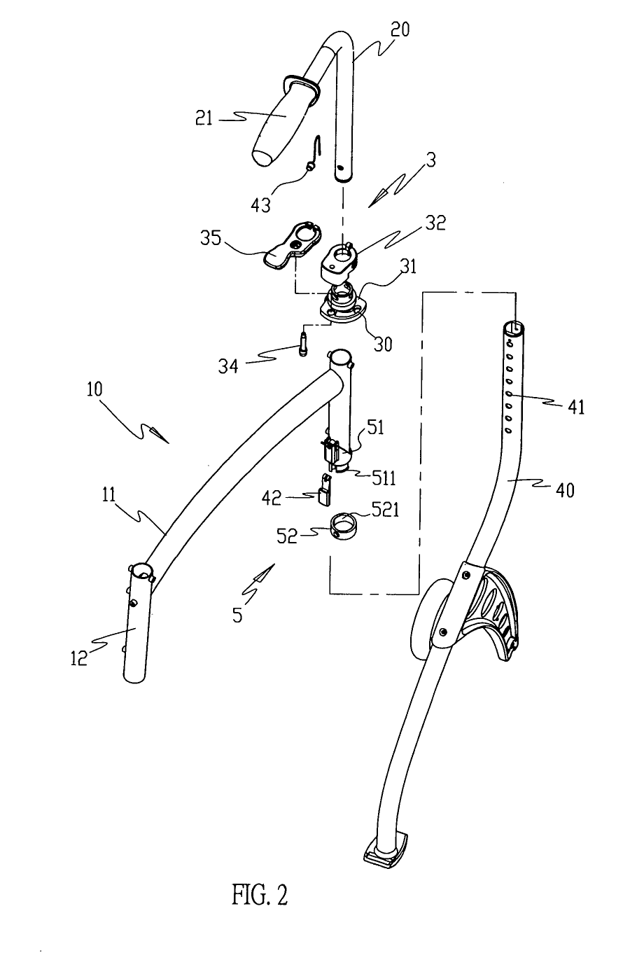

Referring to FIGS. 1 and 2, the present invention is a locking mechanism for a foldable walker for stabilizing and reducing shaking of a walker frame upon adjusting height of the walker. The walker includes a frame 10, a handle bar 20, a foldable device 3 and a supporting leg 40.

The frame 10 includes a cross brace 11 and each end of the cross brace 11 is connected with a fixed tube 12 which is disposed vertically to the cross brace 11. The cross brace 11 and the fixed tube are in a configuration as a H-like or U-like shape.

The handle bar 20 is rotatable telescoped inside the fixed tube 12 and is provided with a grip for a user to hold.

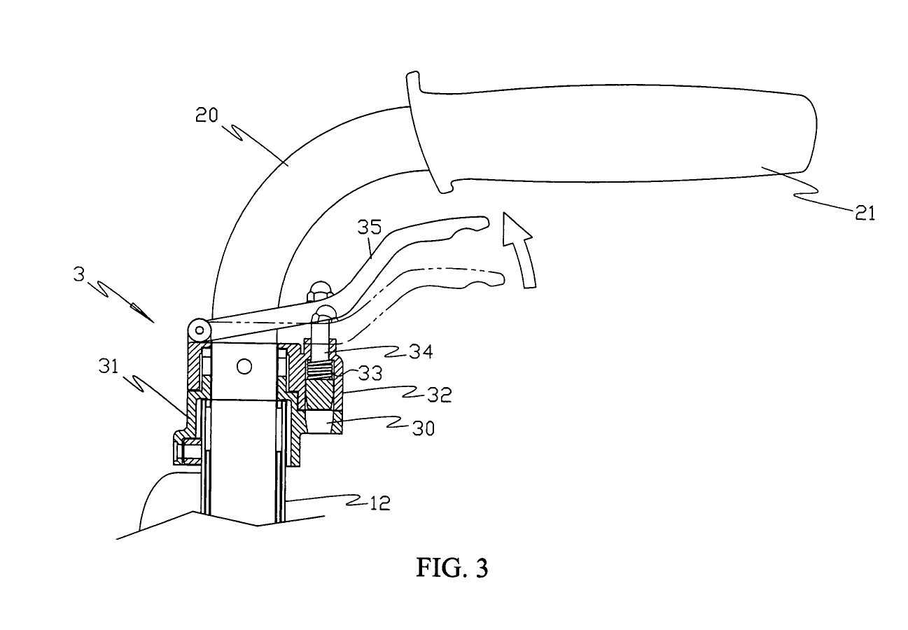

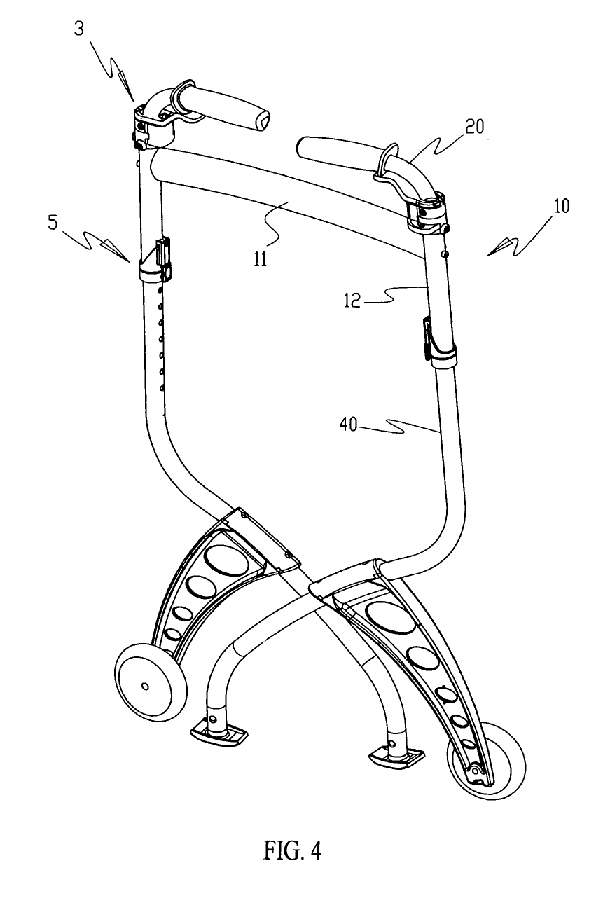

Referring to FIGS. 3, the foldable device 3 is arranged between the frame 10 and handle bar 20. In the present invention, the foldable device 3 includes a fixed plate 31, a rotating base 32, an elastic member 33, a pin 34 and a operator 35. The the fixed plate 31 is fixed to an upper end of the fixed tube 12. The top surface of the fixed plate 31 at least has a positioning hole 30. The rotating base 32 is located at a lower end of the handle bar 20 for passing through by the pin 34. The operator 35 is movably mounted on the handle bar 20 and can be rotated by turning the handle bar 20. One side of the operator 35 is connected to the pin 34 so as the pin 34 can pass through the rotating base 32 and be fix inside the positioning hole 30. As shown in FIG. 1, when the handle bar 20 is turning under an operation position and the handle bar 20 is vertical to the cross brace 11, the pin 34 is confined to the positioning hole 30 by the elastic member 33. When the user folds the handle bar 20, the operator 35 is pulled upward so that the pin 34 can be disengaged from the positioning hole 30. As shown in FIG. 4, the handle bar 20 is rotated and is parallel or overlapped to the cross brace 11 for storage.

The supporting leg 40 is telescoped to the fixed tube 12 and the handle bar 20 inside. In the present invention, the supporting leg 40 is provided with adjusting holes 41 which are spaced apart and are in alignment. A button 42 is associated with a spring 43 so as to adjust the length and fix the related handle bar 20. The spring 43 is disposed inside and projected from the handle bar 20 in order to fix and position the adjusting holes 41 of the supporting leg 40. Therefore, upon turning the handle bar 20, the supporting leg 40 is rotated together with the handle bar 20.

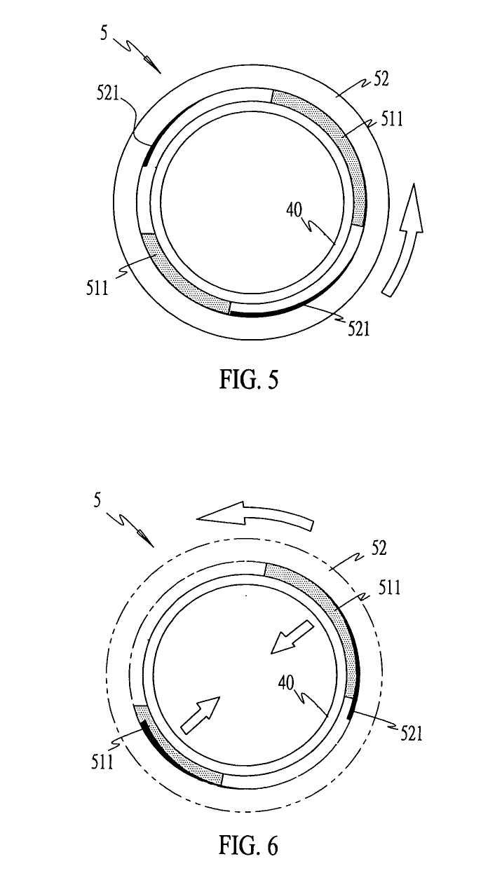

Further referring to FIGS. 2, 5 and 6, the securing device 5 is located between the frame 10 and supporting leg 40. The securing device 5 has a securer 51 and a rotating ring 52, wherein the securer 51 is fixed to the lower end of the fixed tube 12 and a securing piece 511 with a pair of free ends is extended from the lower end of the securer 51. The securing piece 511 is disposed at one side of the supporting leg 40. In addition, the rotating ring 52 is overlapped with the external edge of the securing piece 511 and connected to the supporting leg 40. Since the supporting leg 40 is telescoped to the handle bar 20, the rotating ring 52 can rotate the securing piece 511 while turning together by the handle bar 20, and the inside diameter of the rotating ring 52 is provided with a pressing edge 521. The securing piece 511 is flexible and it can be either plastic or a metal slice. Upon turning the rotating ring 52, the pressing edge 521 presses the securing piece 511 and because of the securing piece 511 has the free ends, the securing piece 511 via its flexibility presses the supporting leg 40. Therefore, shaking is reduced with the supporting leg 40 relative to the fixed tube 12 of the frame 10, and the stability of the frame 10 is achieved.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A locking mechanism for foldable walker, is disposed on a frame of the walker, comprising:
a supporting leg, provided for connecting with connected to the frame, the supporting leg being retractable capable of movably retracting and positioning;
a securing device, including a securer and a rotating ring, wherein the securing device is fixed to the frame and downward extends a securing piece; and the rotating ring is provided with a pressing edge and located outside the securing piece, when the rotating ring is forced to turn, the pressing edge presses the securing piece to secure the supporting leg to stably support the leg.

2. The locking mechanism of claim 1, wherein the frame includes a cross brace and a pair of fixed tubes each fixed to each end of the cross brace vertically.

3. The locking mechanism of claim 1, wherein a foldable device is disposed between the frame and a handle bar, and the handle bar can be rotated by the foldable device into either an expanded position of disposed vertically relative to the cross brace or into a folded position disposed parallel or overlapped to the cross brace.

4. The locking mechanism of claim 1, wherein the foldable device includes a fixed plate, a rotating base, an elastic member, a pin and an operator; the fixed plate being fixed to an upper end of the fixed tube and having at least a positioning hole on it's a top surface thereof for receiving the pin; and the operator being movably mounted on the handle bar and being rotatable along with the handle bar; one side of the operator being connected to the pin so as the pin can pass through the rotating base and the pin is confined to the positioning hole by the elastic member.

5. The locking mechanism of claim 1, wherein the supporting leg is provided with aligned, spaced apart adjusting holes associated with a spring inside the handle bar for adjusting length along the fixed tube and achieving height adjustment of the frame.

6. The locking mechanism of claim 1, wherein the securing piece is elastic and is at least one of a plastic piece and a metal slice and wherein the securing piece presses the supporting leg.

7. The locking mechanism of claim 1, wherein the rotating ring is rotatable by a handle bar.

8. The locking mechanism of claim 7, wherein the handle bar is rotatable and fixable.
